(19) United States
(12) Patent Application Publication
(10) Pub. No.: US 2002/0180967 A1
(43) Pub. Date: Dec. 5, 2002

(54) Light wavelength measuring instrument, light wavelength measuring method and laser apparatus

(76) Inventors: Koji Shio, Hiratsuka (JP); Osamu Wakabayashi, Hiratsuka (JP); Toru Suzuki, Hiratsuka (JP)

Correspondence Address: STEVENS, DAVIS, MILLER & MOSHER, L.L.P., Suite 850, 1615 L Street, N.W., Washington, DC, 20036, US

(21) Appl. No.: 09/871,668

(22) Filed: Jun. 4, 2001

(51) Int. Cl. G01J 3/12

(52) U.S. Cl. 356/326; 356/328

(57) ABSTRACT

In a light wavelength measuring instrument, a wavelength approximated to a wavelength of a light beam to be measured can be simply selected from light beams, whose spectrum distributions are previously known, as a measurement basis of a wavelength of the light beam to be measured. The light wavelength measuring instrument includes: a reference light source for emitting a reference light beam having a known spectrum distribution; a first spectrometer for spectrum-separating at least the reference light beam; a second spectrometer, having higher resolving power than that of the first spectrometer, for spectrum-separating the light beam to be measured and the reference light beam; and a detector for detecting both the light beam to be measured and the reference light beam emitted from the second spectrometer.

### BACKGROUND OF THE INVENTION

1. Field of the Invention

The present invention is related to a light wavelength measuring instrument and a light wavelength measuring method, capable of selecting a wavelength component approximated to a wavelength of a light beam under measurement from a plurality of such light beams having previously-known spectrum distributions, and measuring the wavelength of the light beam under measurement, while using the selected wavelength component as a measurement reference. Also, the present invention is related to a laser apparatus having a function of measuring an oscillated wavelength of a laser beam in accordance with the light wavelength measuring method.

2. Description of a Related Art

In exposure stages used in manufacturing process of semiconductor devices, while patterns which are transferred to substrates which is given a coat of resist are made narrow in very fine manners, a strong demand is made to improve resolving power of semiconductor exposure apparatus. Therefore, as light sources employed in semiconductor exposure apparatus, a specific attention is paid to laser apparatus capable of producing narrow-band laser beams. In such a laser apparatus, while an oscillated wavelength of a laser beam is measured, a laser oscillator is required to be controlled in such a manner that a measured value (namely, measured oscillated wavelength of laser beam) may be maintained at a target wavelength value.

Japanese Laid-open Patent Application JP-A-5-95154 discloses the following laser apparatus. That is, the laser apparatus have such functions of emitting an atomic fluorine laser beam, narrowing and emitting a molecular fluorine laser beam, and measuring the oscillated wavelength of the molecular fluorine laser beam by using the oscillated wavelength of the atomic fluorine laser beam as the measurement basis.

However, since the oscillated wavelength of the atomic fluorine laser beam belongs to the visible range, the oscillated wavelength of the atomic fluorine laser beam is largely different from the oscillated wavelength (vacuum ultraviolet range) of the molecular fluorine laser beam. As a consequence, when the laser apparatus disclosed in the above-described JP-A-5-95154 is employed, the oscillated wavelength of the molecular fluorine laser beam cannot be measured with high precision. Therefore, while a measurement is carried out as to a wavelength of a light beam having a narrow spectrum distribution such as a narrow-band laser beam, a correct reference is necessarily required.

To this end, Japanese Patent Disclosures JP-B2-2631553 and JP-B2-2631569 disclose the following apparatus. That is, the apparatus includes the reference light source for emitting a reference light beam having such a wavelength component approximated to the oscillated wavelength of the laser beam, and have such functions of spectrum-separating the reference light beam by using one spectrometer and selecting such a wavelength component approximated to the oscillated wavelength of the laser beam from the reference light beams emitted from the spectrometer.

By the way, generally speaking, atoms and molecules which radiate light containing a very large number of wavelength components are filled into a chamber of such a reference light source. Such light is utilized as reference light beams. Also, when a light beam is spectrum-separated by a spectrometer, there is a certain possibility that a so-called “folding” phenomenon occurs. That is, a wavelength component belonging to a predetermined wavelength range appears in a different wavelength range from the first-mentioned wavelength range. The occurrence rate of the “folding” phenomenon would be increased in connection with such a fact that resolving power of the spectrometer is increased.

While such a reference light beam is utilized which contains a wavelength component approximated to an oscillated wavelength of a laser beam, in order to measure an oscillated wavelength of a narrow-band laser beam with high precision, the reference light beam should be spectrum-separated in high resolving power. Normally, such a reference light beam, however, contains a very large number of wavelength components. As a consequence, when the reference light beam containing the very large number of wavelength components is spectrum-separated in high resolving power, the large number of wavelength components contained in the reference light beam come closely to each other or are overlapped with each other. As a result, it is practically difficult to precisely select such a wavelength component approximated to the oscillated wavelength of the laser beam from these many wavelength components.

### SUMMARY OF THE INVENTION

The present invention has been made to solve the above-described problem, and therefore, has an object to provide both an apparatus and a method in which a wavelength component approximated to a wavelength of a light beam to be measured can be easily selected from a reference light beam emitted from a reference light source, while the wavelength of the light beam to be measured is employed as a measurement basis. Also, another object of the present invention is to provide such a laser apparatus having a function capable of selecting a measurement basis of an oscillated wavelength of a laser beam in such a manner.

To achieve above-explained objects, a light wavelength measuring instrument according to the present invention comprises: a reference light source for emitting a reference light beam having a known spectrum distribution; a first spectrometer for spectrum-separating at least the reference light beam from among a light beam to be measured emitted from a light source and the reference light beam emitted from the reference light source; a second spectrometer, having higher resolving power than that of the first spectrometer, for spectrum-separating the reference light beam emitted from the first spectrometer and the light beam to be measured emitted from either one of the light source and the first spectrometer; a detector for detecting both the light beam to be measured and the reference light beam emitted from the second spectrometer; and a measuring unit for selecting a wavelength component approximated to a wavelength of the light beam to be measured detected by the detector from wavelength components of the reference light beam detected by the detector, and measuring a wavelength of the light beam to be measured on the basis of the selected wavelength component.

Also, a light wavelength measuring method according to the present invention comprises: a first step of spectrum-separating at least a reference light beam from among a light beam to be measured emitted from a light source and the reference light beam emitted from a reference light source by using a first spectrometer; a second step of spectrum-separating the reference light beam emitted from the first spectrometer and the light beam to be measured emitted from either one of the light source and the first spectrometer by using a second spectrometer having higher resolving power than that of the first spectrometer; a third step of detecting the light beam to be measured and the reference light beam emitted from the second spectrometer by using a detector; and a fourth step of selecting a wavelength component approximated to a wavelength of the light beam to be measured detected by the detector from wavelength components of the reference light beam detected by the detector, and measuring a wavelength of the light beam to be measured on the basis of the selected wavelength component.

Furthermore, a laser apparatus according to the present invention comprises: a laser oscillator for emitting a laser beam; a reference light source for emitting a reference light beam having a known spectrum distribution; a first spectrometer for spectrum-separating at least the reference light beam from among the laser beam emitted from the laser oscillator and the reference light beam emitted from the reference light source; a second spectrometer, having higher resolving power than that of the first spectrometer, for spectrum-separating the reference light beam emitted from the first spectrometer and the laser beam emitted from either one of the laser oscillator and the first spectrometer; and a detector for detecting the laser beam and the reference light beam emitted from the second spectrometer.

In accordance with the present invention, the reference light beam emitted from the reference light source is spectrum-separated by the first spectrometer having low resolving power so as to derive such a wavelength component approximated to the oscillated wavelength of the laser beam from the spectrum-separated reference light beam. At this time, the wavelength components unnecessary for measuring the oscillated wavelength of the laser beam are eliminated from the reference light beam. The unnecessary wavelength components would cause “folding” phenomenon in the second spectrometer having high resolving power. Thereafter, the wavelength components, which are derived from the reference light beam by the first spectrometer, are spectrum-separated by the second spectrometer having high resolving power. As a consequence, the second spectrometer can easily obtains the desirable wavelength component which is approximated to the oscillated wavelength of the laser beam from the reference light beam with high precision as the measurement basis for measuring the oscillated wavelength of the laser beam.

### BRIEF DESCRIPTION OF THE DRAWINGS

FIG. 1 is a schematic block diagram showing a basic arrangement of a light wavelength measuring instrument according to one embodiment of the present invention;

FIG. 2 is a diagram representing concrete examples of atoms and molecules filled into a reference light beam source in FIG. 1, and portions of wavelength components of light emitted from these atoms and molecules;

FIG. 3 is a diagram schematically showing a concrete example of a spectrometer having low resolving power in FIG.

FIG. 4A is a front view representing a structure of a detector in FIG. 3, FIG. 4B is a side view representing the structure of the detector in FIG. 3, and FIG. 4C is a diagram representing interference fringes which are formed on a slit plate included in the detector;

FIG. 5 is a diagram representing an example of a spectrum distribution (reference pattern) which is referred while the spectrometer in FIG. 3 is calibrated;

FIG. 6 is a diagram representing an example of a spectrum distribution (reproduction pattern) which is reproduced based upon a detection result of a line sensor while the spectrometer in FIG. 3 is calibrated;

FIG. 7 is a diagram schematically showing another concrete example of the spectrometer having low resolving power in FIG. 1;

FIG. 8 is a diagram representing an example of interference fringes which are formed by a reference light beam emitted from etalon in FIG. 7;

FIG. 9 is diagram representing an example of interference fringes which are formed by a reference light beam emitted from a grating shown in FIG. 7;

FIG. 10 is a diagram representing an example of a light intensity distribution, taken along a lateral line in FIG. 9;

FIG. 11 is a diagram showing a concrete example of the spectrometer having high resolving power as shown in FIG. 1;

FIG. 12 is a diagram showing another concrete example of the spectrometer having high resolving power shown in FIG. 1; and

FIG. 13 is a schematic diagram showing an entire arrangement of a laser apparatus according to one embodiment of the present invention.

### DESCRIPTION OF THE PREFERRED EMBODIMENTS

Referring now to drawings, various preferred embodiments of the present invention will be described in detail.

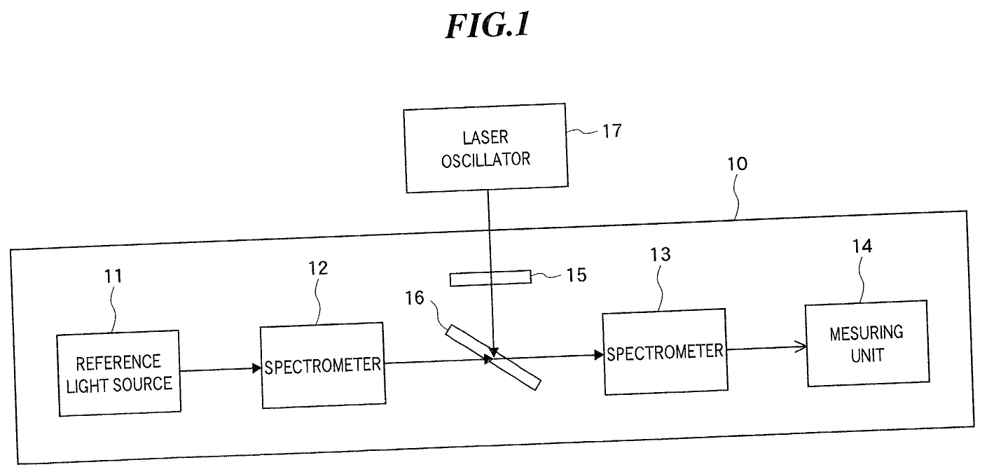

FIG. 1 is a schematic block diagram showing a basic arrangement of a light wavelength measuring instrument according to one embodiment of the present invention. The light wavelength measuring instrument 10 corresponds to such an apparatus employed to measure an oscillated wavelength (namely, 157.6299 nm) of a narrow-band molecular fluorine laser beam (F₂-laser light beam). The light wavelength measuring instrument 10 mainly includes a reference light source 11, spectrometers 12 and 13, a measuring unit 14 and so on.

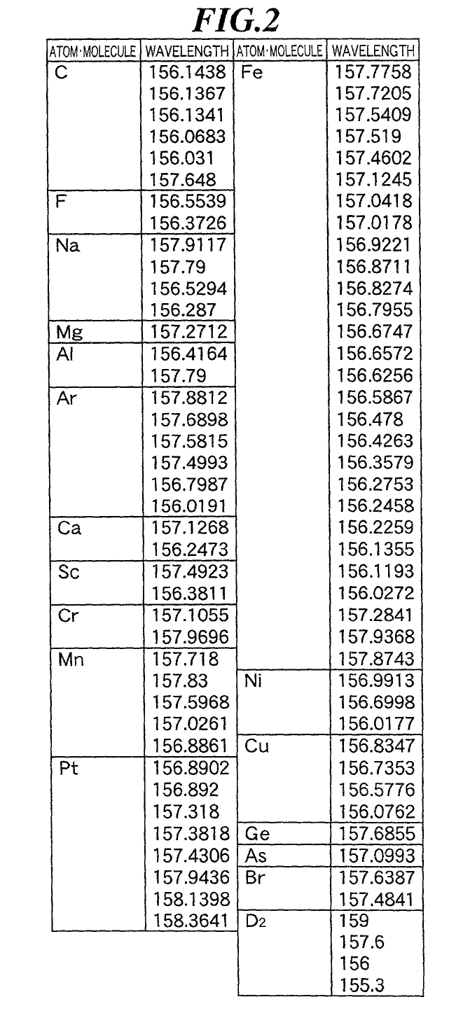

At least one sort of the below-mentioned chemical elements is filled into a chamber of the reference light beam source 11, for instance, carbon (C), fluorine (F), sodium (Na), magnesium (Mg), aluminum (Al), argon (Ar), calcium (Ca), scandium (Sc), chromium (Cr), manganese (Mn), platinum (Pt), iron (Fe), nickel (Ni), copper (Cu), germanium (Ge), arsenic (As), bromine (Br), and heavy hydrogen (D₂). As indicated in FIG. 2, these atoms and molecules radiate light by an electric discharge or the like, which light contains such a wavelength component approximated to an oscillated wavelength of an F₂-laser light beam. For instance, in the case of bromine (Br), wavelength components are 157.4841 nm and 157.6387 nm. The reference light source 11 emits a reference light beam by using the light emitted by such atoms and molecules.

The spectrometer 12 spectrum-separates the reference light beam emitted from the reference light source 11 in low resolving power. Now, a description will be made of a concrete example of the spectrometer 12 having low resolving power.

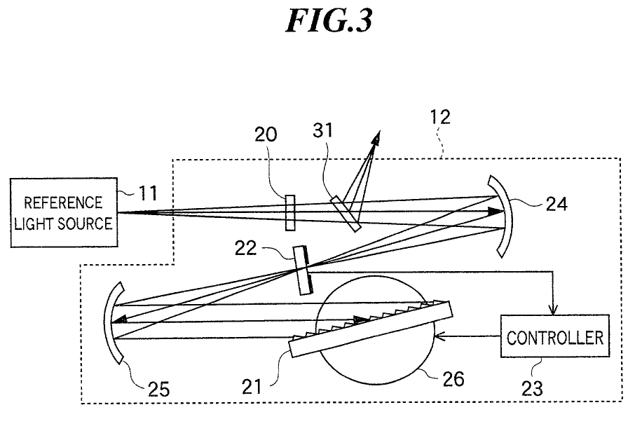

FIG. 3 is a diagram for schematically showing a concrete example of the above-described spectrometer 12. In FIG. 3, the spectrometer 12 mainly includes a band-pass filter 20, a grating 21, a detector 22, a controller 23 and so on.

The band-pass filter 20 cuts off such a wavelength component largely different from the oscillated wavelength of the F₂-laser light beam from reference light beams incident upon the spectrometer 12. As a result, the band-pass filter 20 can roughly eliminate such a wavelength component unnecessary for carrying out the measurement of the oscillated wavelength of the F₂-laser light beam from the reference light beam incident upon the spectrometer 12. It should be noted that, for example, an interference filter and the like may be employed as the above-described band-pass filter 20.

A concave mirror 24 is arranged at the right hand of the band-pass filter 20. The concave mirror 24 reflects reference light beam which has passed through the band-pass filter 20 toward the detector 22. At this time, the reflected reference light beam is collected by the concave mirror 24. Then, a portion of the reference light beam which is reflected from the concave mirror 24 toward the detector 22 passes through a slit (will be explained later) of the detector 22.

Another concave mirror 25 is arranged at the left hand of the detector 22. The concave mirror 25 reflects such a reference light beam which is reflected from the concave mirror 24 and furthermore passed through the slit of the detector 22 toward the grating 21. At this time, the reference light beam is collimated by the concave mirror 25.

The grating (for instance, holographic grating) 21 is one of spectrum-separating elements capable of spectrum-separating an incident light beam in low resolving power. A plurality of groove lines for diffracting the incident light beam are formed in one surface of the grating 21. The grating 21 is installed on a rotary stage 26 arranged at the right hand of the concave mirror 25, and diffracts the reference light beam collimated by the concave mirror 25. Then, a portion of the reference light beam emitted from the grating 21 is reflected from the concave mirror 25 toward the detector 22.

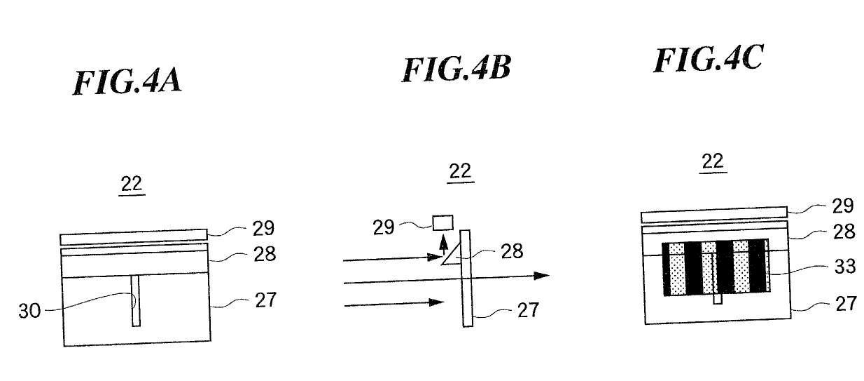

FIGS. 4A-4C illustratively represent a structure and so on of the detector 22. The detector 22 includes a slit plate 27, a mirror 28, a line sensor 29, and so on. A slit 30, through which a portion of incident light passes, is formed in the slit plate 27. A triangle pole-shaped mirror 28 is put on one surface of the slit 27. Diffraction fringes 33 are formed on the surface of the triangle pole-shaped mirror 28 by the reference light beam which is emitted from the grating 21 and is furthermore reflected from the concave mirror 25. At this time, a portion of the reference light beam which forms the diffraction fringes 33 is reflected from the mirror 28 in the upper direction. In the diffraction fringes, a left-sided diffraction fringe corresponds to a long wavelength range, whereas a right-sided diffraction fringe corresponds to a short wavelength range.

The line sensor 29 is arranged above the mirror 28. A plurality of channels containing photo-detecting elements (for example, photodiodes) are arrayed in an one-dimensional manner on the line sensor 29, and the plurality of channels output sensor signals in response to received light amount thereof. The line sensor 29 detects reference light beam which is reflected from the mirror 28 by actuating these channels. Then, the detection results of the line sensor 29 are input into a controller 23.

The controller 23 calibrates the spectrometer 12 based upon the detection result of the line sensor 29. The calibration to the spectrometer 12 by the controller 23 is carried out in accordance with the below-mentioned manner:

(1) First, an intensity distribution (namely, reproduction pattern) of a reference light beam is reproduced based upon the detection result of the line sensor 29, as represented in FIG. 5. Since the grating 21 owns low resolving power, only such a reference light beam of a specific diffraction order which is emitted from the grating 21 reaches the slit plate 27, so that the diffraction fringes 33 are produced. As a consequence, in the reproduction pattern, a spectrum distribution corresponding to the specific diffraction order is also represented.

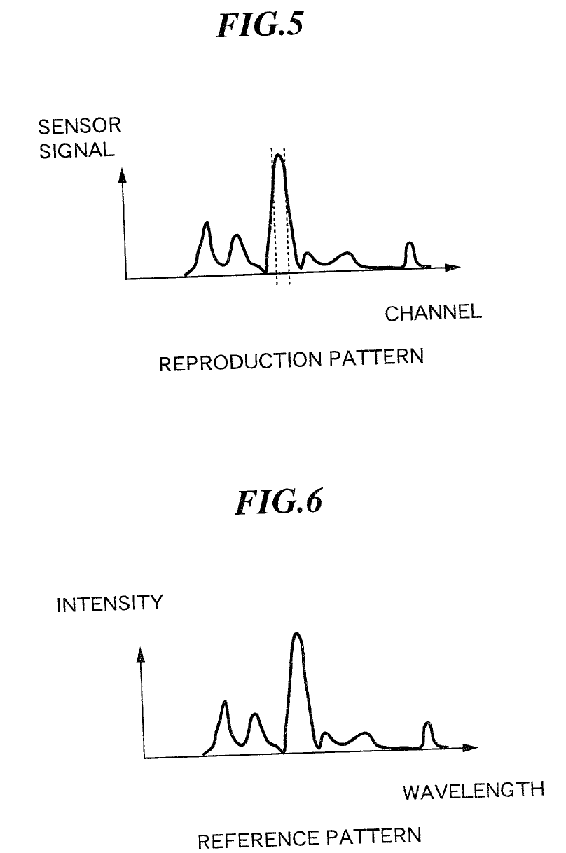

(2) Such an intensity distribution (namely, reference pattern) as shown in FIG. 6 is stored into the controller 23 as a reference to be used for calibrating the spectrometer 12. Therefore, by comparing the reproduction pattern with the reference pattern, the controller 23 judges whether or not a wavelength component of a target (namely, wavelength component approximated to oscillated wavelength of F₂-laser light beam) contained in the reference light beam passes through the slit 30 (corresponding to a dot line portion in FIG. 5).

(3) Then, in such a case where the controller 23 judges that the wavelength component of the target does not pass through the slit 30, the controller 23 controls the rotary stage 26 in order that the wavelength component of the target may pass through the slit 30. By the control operation, an angle of the grating 21 to the optical axis is adjusted, so that the spectrometer 12 is calibrated. By calibrating the spectrometer 12 in the above-mentioned manner, such a wavelength component approximated to the oscillated wavelength of the F₂-laser light beam can be easily derived from the reference light beam emitted from the reference light beam source 11.

Referring back to FIG. 3, the spectrometer 12 is again explained. A beam splitter 31 is arranged between the band-pass filter 20 and the concave mirror 24. The beam splitter 31 splits an incident light beam into two light beams in two directions. The beam splitter 31 reflects a portion of the reference light beam, which passes through the slit 30 and is furthermore reflected from the concave mirror 24, in the upper direction. Then, the reference light beam which is reflected from the beam splitter 31 is incident upon the spectrometer 13 (see FIG. 1).

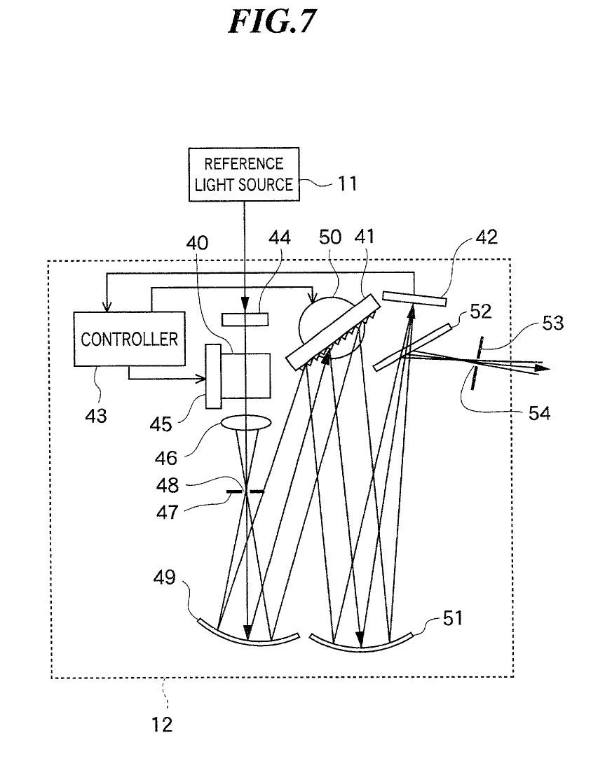

FIG. 7 is a schematic diagram illustratively showing another concrete example of the spectrometer 12. In FIG. 7, the spectrometer 12 mainly includes an etalon 40, a grating 41, a CCD (charge coupled device) 42, a controller 43, and so on.

In FIG. 7, the reference light beam incident upon the spectrometer 12 passes through a diffusion plate 44 so as to be diffused. A rotary stage 45 is arranged below the diffusion plate 44, and the etalon 40 is further arranged on the rotary stage 45. The etalon 40 is one of spectrum-separating elements for spectrum-separating an incident light beam in high resolving power. The etalon 40 spectrum-separates a portion of reference light beam which has passed through the diffusion plate 44 in high resolving power.

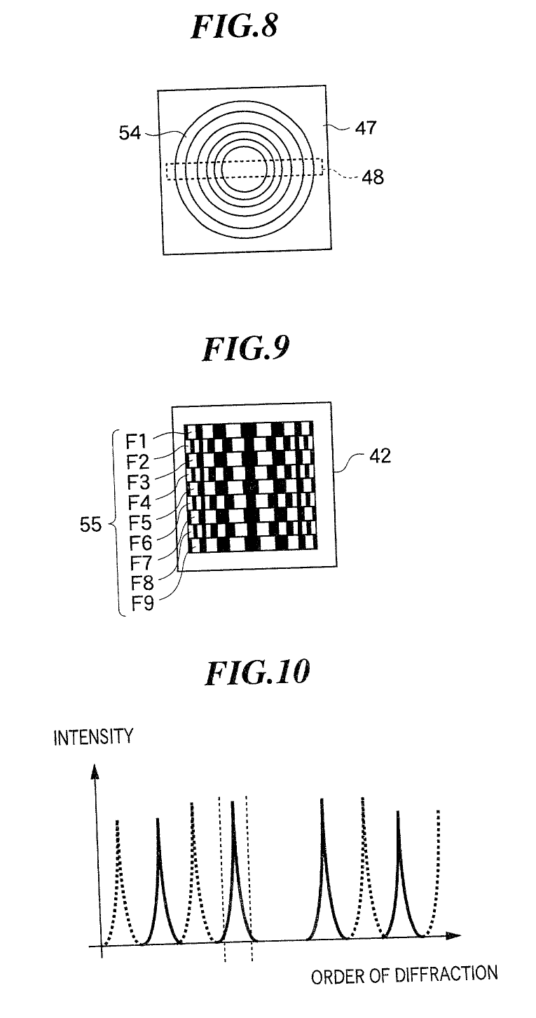

A lens 46 is arranged below the rotary stage 45. The lens 46 focuses a portion of reference light beam which passes through the etalon 40 in the lower direction. A slit plate 47 is arranged below the lens 46. A slit 48, through which a portion of incident light passes, is formed in the slit plate 47. Therefore, a large number of wavelength components contained in such a reference light beam which has passed through the etalon 40 and the lens 46 in this order come closely to each other or are overlapped with each other on the slit plate 47, so that interference fringes 55 as shown in FIG. 8 are formed. Then, a portion of these interference fringes 55 passes through the slit 48 (namely, a broken line portion in FIG. 8).

Again, the spectrometer 12 will now be explained with reference to FIG. 7. A concave mirror 49 is arranged below the slit plate 47. The concave mirror 49 reflects the reference light beam, which passes through the slit 48, in the upper direction. At this time, the reflected reference light beam is collimated by the concave mirror 49. A rotary stage 50 is arranged at the right hand of the diffusion plate 44, and also the grating 41 arranged above the rotary stage 50.

The grating 41 diffracts the reference light beam collimated by the concave mirror 49. As a consequence, the reference light beam, which passes through the slit 48 and is reflected from the concave mirror 49, is spectrum-separated in low resolving power. Thus, a large number of wavelength components, which are contained in the spectrum-separated reference light beam and coming closely to each other or overlapped with each other, are resolved in the multiple directions.

A concave mirror 51 is arranged at the right hand of the concave mirror 49. The concave mirror 51 reflects a portion of the reference light beam emitted from the grating 41 in the upper direction. At this time, the reflected reference light beam is collected by the concave mirror 51. A beam splitter 52 is arranged at the right hand of the rotary stage 50. The beam splitter 52 splits the reference light beam reflected from the concave mirror 51 in two directions.

The CCD 42 is arranged above the beam splitter 52, and also, a pinhole plate 53 is arranged at the right hand of the beam splitter 52. As a consequence, as shown in FIG. 9, the reference light beam which has penetrated through the beam splitter 52 forms diffraction fringes 56 which are separated into a plurality of fringes F1-F9. Similarly, the diffraction fringes 56 are formed on the pinhole plate 53 by way of the reference light beam reflected from the beam splitter 52.

It should also be understood that in the diffraction fringes 56, a vertical direction constitutes a wavelength distribution in low resolving power, whereas a lateral direction constitutes a wavelength distribution in high resolving power. Therefore, the diffraction fringes 56 are moved up and down by adjusting the angle of the grating 41 to the optical axis. Also, the diffraction fringes 56 are moved right and left by adjusting the angle of the etalon 40 to the optical axis.

A plurality of channels are arrayed on the CCD 42 in a two-dimensional manner. The CCD 42 detects a reference light beam which has penetrated through the beam splitter 52 by using these channels. Then, the detection result of the CCD 42 is input into the controller 43. A pinhole 54, through which a portion of incident light beam passes, is formed in a pinhole plate 53. A portion of the reference light beam reflected from the beam splitter 52 passes through the pinhole 54. Then, the reference light beam which passed through the pinhole 54 is incident upon the spectrometer 13 (see FIG. 1).

The controller 43 calibrates the spectrometer 12 based upon the detection result of the CCD 42. The calibration of the spectrometer 12 by the controller 43 is carried out in accordance with the below-mentioned manner:

(1) The controller 43 selects a fringe (namely, fringe F₅ in FIG. 9) of a wavelength range containing the oscillated wavelength of the F₂-laser light beam from the diffraction fringes 56 formed on the CCD 42. Then, the controller 43 reproduces an intensity distribution as represented in FIG. 10 based upon the selected fringe. In FIG. 10, a solid line indicates a wavelength component of a target (namely, a wavelength component approximated to the oscillated wavelength of F₂-laser light beam) contained in the reference light beam, and a broken line indicates one of wavelength components other than the wavelength component of the target contained in the reference light beam.

(2) Next, the controller 43 judges as to whether or not the wavelength component of the target passes through the pinhole 54 (corresponding to a dot line portion in FIG. 10) based upon the reproduced intensity distribution.

(3) In the case where the controller 43 judges that the wavelength component of the target does not pass through the pinhole 54, the controller 43 controls both the rotary stages 45 and 50 in such a manner that the wavelength component of the target may pass through the pinhole 54. By carrying out the control operation, the angles of the etalon 40 and the grating 41 to the optical axis are adjusted, so that the spectrometer 12 is calibrated. As a consequence, by calibrating the spectrometer 12 in the above-explained calibration manner, one of wavelength components approximated to the oscillated wavelength of the F₂-laser light beam can be easily derived from the reference light beam emitted from the reference light beam source 11.

The spectrometer 13 spectrum-separates a portion of the reference light beam which has penetrated through the beam splitter 16, and also a portion of the F₂-laser light beam which is reflected from the beam splitter 16 in high resolving power. Now, a description will be made of a concrete structural example of the spectrometer 13.

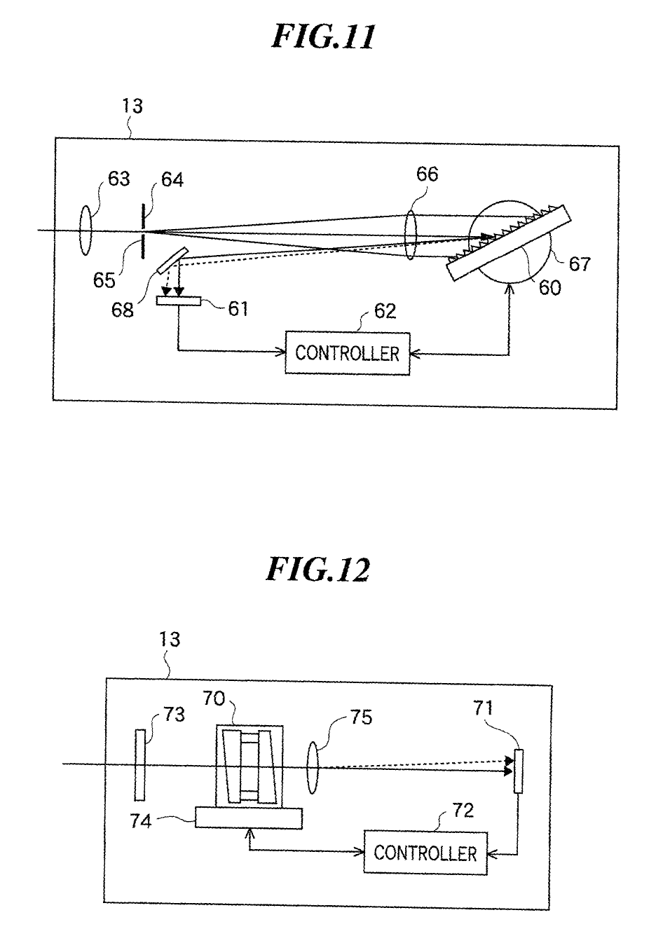

FIG. 11 is a schematic diagram showing an example of a concrete structure of the spectrometer 13. In FIG. 11, the spectrometer 13 mainly includes an Echelle grating 60, a line sensor 61, a controller 62, and so on.

In FIG. 11, an F₂-laser light beam or a reference light beam incident upon the spectrometer 13 passes through a lens 63 and then, is collected in the right direction. A slit plate 64 is arranged at the right hand of the lens 63, and a slit 65, through which a portion of incident light passes, is formed in the slit plate 64. The slit 65 permits a portion of the F₂-laser light beam or a portion of the reference light beam that has passed through the lens 63 to pass therethrough.

A collimator lens 66 is arranged at the right hand of the slit plate 64. The collimator lens 66 collimates the F₂-laser light beam or the reference light beam which has passed through the slit 65 in the right direction. A rotary stage 67 is arranged at the right hand of the collimator lens 66 and further, the Echelle grating 60 is arranged on the rotary stage 67. The Echelle grating 60 is one of gratings having high resolving power, and diffracts the F₂-laser light beam or the reference light beam collimated by the collimator lens 66.

A mirror 68 is arranged below the slit plate 64. The mirror 68 reflects a portion of the F₂-laser light beam or a portion of the reference light beam (namely, F₂-laser light beam or reference light beam of a high diffraction order), which have been emitted from the Echelle grating 60, in the lower direction. The line sensor 61 is arranged under the mirror 66. The line sensor 61 detects the F₂-laser light beam (solid line) reflected from the mirror 66 or a wavelength component of the reference light beam (broken line) which is approximated to the oscillated wavelength of the F₂-laser light beam. Then, the detection results of the line sensor 61 are input into both the controller 62 and the measuring unit 14 (see FIG. 1).

The controller 62 controls the rotary stage 67 in order that the F₂-laser light beam incident upon the spectrometer 13 can be detected by the line sensor 61. Thereafter, the controller 62 controls the rotary stage 67 in order that the wavelength component, which is contained in the reference light beam incident upon the spectrometer 13 and approximated to the oscillated wavelength of the F₂-laser light beam, can also be detected by the line sensor 61. By carrying out the control operation of these rotary stages, the angle of the Echelle grating 60 to the optical axis is adjusted, so that the spectrometer 13 is calibrated. By calibrating the spectrometer 13 in this manner, the line sensor 61 can detect both of the wavelength component of the F₂-laser light beam and the wavelength component of the reference light beam which is approximated to the F₂-laser light beam.

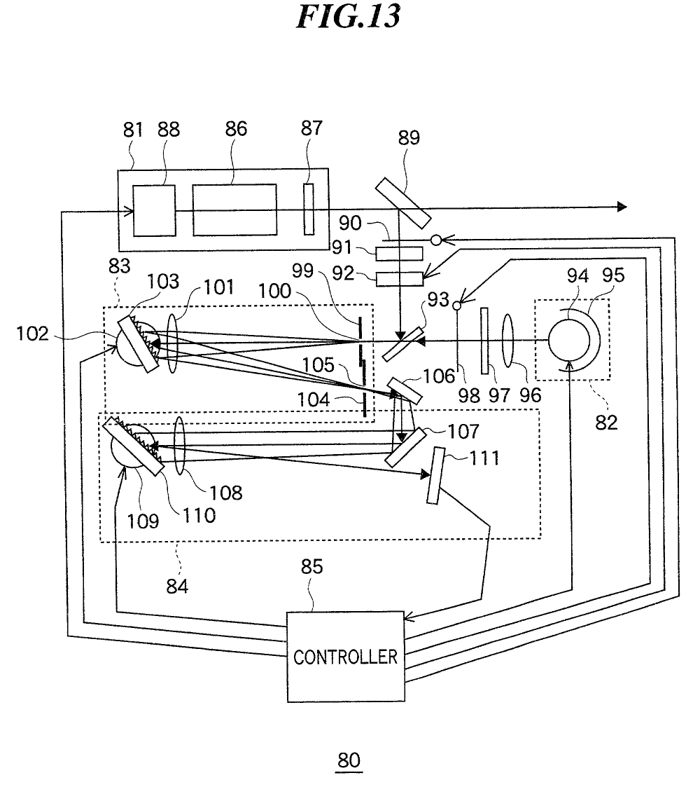

FIG. 12 illustratively shows another example of a concrete structure of the above-explained spectrometer 13. In FIG. 12, the spectrometer 13 mainly includes an etalon 70, a line sensor 71, a controller 72, and so on.

In FIG. 12, an F₂-laser light beam or a reference light beam incident upon the spectrometer 13 passes through a scattering plate 73 so as to be scattered. A rotary stage 74 is arranged at the right hand of the scattering plate 73, and further, the etalon 70 is arranged on the rotary stage 74. The etalon 70 spectrum-separates the F₂-laser light beam and the reference light beam, which has passed through the scattering plate 73, in high resolving power.

A collimator lens 75 is arranged at the right hand of the rotary stage 74. The collimator lens 75 collimates a portion of the F₂-laser light beam or a portion of the reference light beam, which has passed through the etalon 70, in the right direction. The line sensor 71 is arranged at the right hand of the collimator 75. The line sensor 71 detects the F₂-laser light beam (solid line) which has passed through the collimator lens 75 or a wavelength component of the reference light beam (broken line) which is approximated to the oscillated wavelength of the F₂-laser light beam. Then, the detection results of the line sensor 71 are input into both the controller 72 and the measuring unit 14 (see FIG. 1).

The controller 72 controls the rotary stage 74 in order that the F₂-laser light beam incident upon the spectrometer 13 can be detected by the line sensor 71. Thereafter, the controller 72 controls the rotary stage 74 in order that the wavelength component of the reference light beam, which is approximated to the oscillated wavelength of the F₂-laser light beam incident upon the spectrometer 13, can also be detected by the line sensor 71. By carrying out the control operation of these rotary stages, the angle of the etalon 70 to the optical axis is adjusted, so that the spectrometer 13 is calibrated. By calibrating the spectrometer 13 in this manner, the line sensor 71 can detect both the wavelength component of the F₂-laser light beam and the wavelength component of the reference light beam which is approximated to the F₂-laser light beam.

Referring again to FIG. 1, the light wavelength measuring instrument according to the embodiment will now be described.

The output result of the spectrometer 12, namely the detection result of the line sensor 61 or the line sensor 71 is input into the measuring unit 14. The measuring unit 14 measures the oscillated wavelength of the F₂-laser light beam, while employing, as the reference, such a wavelength component which is contained in the reference light beam and approximated to the oscillated wavelength of the F₂-laser light beam.

As previously described in detail, according to the embodiment, the reference light beam emitted from the reference light source 11 is spectrum-separated by using the spectrometer 12 having low resolving power, and such a wavelength component which is approximated to the oscillated wavelength of the F₂-laser light beam is derived from the spectrum-separated reference light beam. At this time, such wavelength components different from the oscillated wavelength of the F₂-laser light beam are eliminated from the spectrum-separated reference light beam. The wavelength components which have been eliminated in this manner would produce, if present, a so-called “folding” phenomenon in the spectrometer 13 having high resolving power. Thereafter, the spectrometer 13 resolves a portion of the reference light beam derived from the spectrometer 12 into the further narrowed wavelength components. As a consequence, since the occurrence of the “folding” phenomenon is effectively suppressed, it is possible to prevent a large number of wavelength components contained in the spectrum-separated reference light beam from coming closely to each other or being overlapped with each other, so that it is also possible to prevent such wavelength components from focusing on the line sensors 61 or 71. Accordingly, the wavelength component approximated to the oscillated wavelength of the laser beam can be easily derived from the reference light beam with high precision, as a measurement basis for the oscillated wavelength of the laser beam. Furthermore, by employing the selected wavelength component as the measurement basis, the oscillated wavelength of the laser beam can be measured with high precision.

In addition, although the line sensors are employed in the embodiment so as to detect the F₂-laser light beam and the reference light beam in the spectrometer 13, an area sensor may be employed instead of the line sensors. In the alternative case, a plurality of wavelength components approximated to the oscillated wavelength of the F₂-laser light beam from the reference light beam can reach the area sensor. These wavelength components may be utilized as the measurement basis of the oscillated wavelength of the F₂-laser light beam.

FIG. 13 schematically shows an entire arrangement of a laser apparatus according to one embodiment of the present invention.

The laser apparatus 80 mainly includes a laser oscillator 81, a reference light source 82, spectrometers 83 and 84, a controller 85, and so on.

The laser oscillator 81 emits an F₂-laser light beam, while a bandwidth of the F₂-laser light beam is narrowed. The laser oscillator 81 includes a laser chamber 86, a front mirror 87, a narrow-band module 88, and so on.

Two electrodes for discharge operation are arranged opposite to each other in the laser chamber 86. A high voltage is applied between the two electrodes for the discharge operation. A laser medium (for example, molecular fluorine) capable of generating an F₂-laser light beam by way of discharge operation is supplied inside the laser chamber 86.

The front mirror 87 is arranged at the right hand of the laser chamber 86. The front mirror 87 reflects a portion of the F₂-laser light beam, and transmits the remaining portion of the F₂-laser light beam therethrough. The narrow-band module 88 is arranged at the left hand of the laser chamber 86. The narrow-band module 88 constitutes with the front mirror 87 such a resonant system which causes the F₂-laser light beam generated in the laser chamber 86 to resonate so as to be amplified. Also, the narrow-band module 88 narrows the bandwidth of the F₂-laser light beam under amplification.

A beam splitter 89 is arranged at the right hand of the front mirror 87. The beam splitter 89 splits the F₂-laser light beam produced form the laser oscillator 81 in two different directions. A shutter 90 is arranged below the beam splitter 89. The shutter 90 is controlled by the controller 85. When the shutter 90 is closed, the F₂-laser light beam reflected from the beam splitter 89 is blocked out.

Ground glass 91 is arranged below the shutter 90. When the shutter 90 is closed, the ground glass 91 scatters the F₂-laser light beam reflected from the beam splitter 89. A light amount adjusting device 92 is arranged below the ground glass 91. By manipulating the light amount adjusting device 92 by using the controller 85, light amount of the F₂-laser light beam incident upon the spectrometer 83 is changed.

Another beam splitter 93 is arranged below the light amount adjusting device 92. Also, the reference light source 82 is arranged at the right hand of the beam splitter 93. Furthermore, the spectrometer 83 is arranged at the left hand of the beam splitter 93. The reference light source 82 includes a lamp 94, a reflection mirror 95, and so on. For instance, atoms or molecules as represented in FIG. 2 are filled into the lamp 94. The reflection mirror 95 reflects a major portion of the light beam emitted from the lamp 94 in the left direction. The reference light source 82 emits such a light beam emitted from those atoms or molecules as a reference light beam.

A lens 96, a band-pass filter 97, and a shutter 98 are arranged in this order from the right side between the reference light source 82 and the beam splitter 93. The lens 96 collects a portion of the reference light beam emitted from the reference light source 82 toward the band-pass filter 97. The shutter 98 is controlled by using the controller 85.

The band-pass filter 97 cuts off such wavelength components which are contained in the reference light beam that has passed through the lens 96 and largely different from the oscillated wavelength of the F₂-laser light beam. As a consequence, the band-pass filter 97 can roughly eliminate such wavelength components, which are unnecessary for measuring an oscillated wavelength of the F₂-laser light beam, from the reference light beam that has passed through the lens 96.

The reference light beam that has passed through the band-pass filter 97 is blocked out by closing the shutter 98. Therefore, if any one of the shutters 90 and 98 is opened and the other is closed, only one of the F₂-laser light beam and the reference light beam is incident upon the spectrometer 83. In the case where the shutter 98 is opened, the beam splitter 93 outputs such a reference light beam which has passed through the band-pass filter 97, or such an F₂-laser light beam which has passed through the light amount adjusting device 92 in one direction.

The spectrometer 83 spectrum-separates the F₂-laser light beam reflected from the beam splitter 93 or the reference light beam which has penetrated through the beam splitter 93 in low resolving power. In FIG. 13, a portion of the F₂-laser light beam or a portion of the reference light beam incident upon the spectrometer 83 passes through the slit 100 of the slit plate 99. A collimator lens 101 is arranged at the left hand of the slit plate 99. The collimator lens 101 collimates the F₂-laser light beam or the reference light beam, which have passed through the slit 100, in the left direction.

A rotary stage 102 is arranged at the left hand of the collimator lens 101. Further, a holographic grating 103 is arranged on the rotary stage 102. The holographic grating 103 diffracts the F₂-laser light beam and the reference light beam which have passed through the lens 101. Then, a portion of the F₂-laser light beam or a portion of the reference light beam emitted from the holographic grating 103 is collected in the right direction by the collimator lens 101.

A slit plate 104 is arranged below the slit plate 99, and a slit 105, through which a portion of incident light passes, is formed in the slit plate 104. A portion of the F₂-laser light beam or a portion of the reference light beam, which has been emitted from the grating 103 and passed through the collimator lens 101, passes through the slit 105. The slit plate 104 owns both functions, namely, a slit used to emit a light beam from the spectrometer 83, and also another slit used to make a light beam incident upon the spectrometer 84.

A mirror 106 is arranged below the beam splitter 93. Further, the spectrometer 84 is arranged below the mirror 106. The mirror 106 reflects the F₂-laser light beam or the reference light beam, which has been emitted from the spectrometer 83, in the lower direction.

The spectrometer 84 spectrum-separates the F₂-laser light beam or the reference light beam reflected from the mirror 106 in high resolving power. In FIG. 13, the F₂-laser light beam or the reference light beam incident upon the spectrometer 84 is reflected by a mirror 107 in the left direction. Another collimator lens 108 is arranged at the left hand of the mirror 107. The collimator lens 108 collimates the F₂-laser light beam or the reference light beam, which has been reflected from the mirror 107, in the left direction.

The rotary stage 109 is arranged at the left hand of the collimator lens 108. Further, an Echelle grating 117 is arranged on the rotary stage 109. The Echelle grating 117 is used to diffract the F₂-laser light beam or the reference light beam collimated by the collimator lens 108. Then, a portion of the F₂-laser light beam or a portion of the reference light beam (namely, F₂-laser light beam or reference light beam of a high diffraction order) emitted from the Echelle grating 110 is collected by the collimator lens 108 in the right direction.

A line sensor 111 is arranged at the right hand of the mirror 107. The line sensor 111 detects such an F₂-laser light beam or such a reference light beam which has been emitted from the grating 110 and passed through the collimator lens 108. Then, the detection result of the line sensor 111 is supplied to the controller 85.

The controller 85 controls the shutters 90 and 98, the light amount adjusting device 92, and the reference light beam source 82. Also, the controller 85 calibrates both the spectrometers 83 and 84 based upon the detection result of the line sensor 111. The calibration to the spectrometers 83 and 84 is carried out by the controller 85 in accordance with the below-mentioned manner:

(1) The controller 85 controls the narrow-band module 88 so as to adjust the laser oscillator 81 in such a manner that the output level of the F₂-laser light beam becomes maximum. At this time, a switch of in the reference light source 82 is turned off, or the shutter 98 is shut so as to prevent the reference light beam emitted from the reference light source 82 from entering both the spectrometers 83 and 84.

(2) The controller 85 controls both the rotary stage 102 and the rotary stage 109 in such a manner that the F₂-laser light beam which has passed through the two spectrometers 83 and 84 maybe detected by the line sensor 11, so that the angles of the gratings 103 and 110 to the optical axis are adjusted.

(3) The controller 85 controls the rotary stages 102 and 109 in such a manner that after the switch of the reference light source 82 is turned on to emit the reference light beam, a portion of such a reference light beam which has passed through the two spectrometers 83 and 84 may also be detected by the line sensor 111, so that the angles of the gratings 103 and 110 to the optical axis are adjusted finely. It should be understood that in the case where the shutter 98 has been shut in the above-described process (1), the shutter 98 should be opened before the control operation is carried out.

(4) By calibrating both the spectrometers 83 and 84 in such a manner, only such a wavelength component, which is contained in the reference light beam and approximated to the oscillated wavelength of the F₂-laser light beam, reaches the line sensor 111. Then, the line sensor 111 output such a detection result corresponding to the wavelength component contained in the reference light beam and approximated to the oscillated wavelength of the F₂-laser light beam.

As previously described in detail, according to the embodiment, the spectrometer 83 having low resolving power spectrum-separates the reference light beam emitted from the reference light source 82 and derives such a wavelength component approximated to the oscillated wavelength of the F₂-laser light beam from the spectrum-separated reference light beam. At this time, such wavelength components different from the oscillated wavelength of the F₂-laser light beam are eliminated from the spectrum-separated reference light beam. The wavelength components eliminated in this manner would produce, if present, a so-called “folding” phenomenon in the spectrometer 84 having high resolving power. Then, the spectrometer 84 resolves a portion of the reference light beam derived from the spectrometer 83 into the further narrowed wavelength components. As a consequence, since the occurrence of the “folding” phenomenon is effectively suppressed, it is possible to prevent a large number of wavelength components, which are contained in the spectrum-separated reference light beam, from coming closely to each other or being overlapped with each other, so that it is also possible to prevent such wavelength components from focusing on the line sensor 111. Accordingly, the wavelength component approximated to the oscillated wavelength of the laser beam can be easily derived from the reference light beam with the high precision, as the measurement basis to the oscillated wavelength of the laser beam. Since the wavelength component is employed as the measurement basis, the oscillated wavelength of the laser beam can be measured with high precision. Then, by controlling the laser oscillator 81 such that the measured value bocomes coincident to the target value, the output laser beam can be maintained with high precision.

1. A light wavelength measuring instrument comprising:
a reference light source for emitting a reference light beam having a known spectrum distribution;
a first spectrometer for spectrum-separating at least the reference light beam from among a light beam to be measured emitted from a light source and the reference light beam emitted from said reference light source;
a second spectrometer, having higher resolving power than that of said first spectrometer, for spectrum-separating the reference light beam emitted from said first spectrometer and the light beam to be measured emitted from either one of said light source and said first spectrometer;
a detector for detecting both the light beam to be measured and the reference light beam emitted from said second spectrometer; and
a measuring unit for selecting a wavelength component approximated to a wavelength of the light beam to be measured detected by said detector from wavelength components of the reference light beam detected by said detector, and measuring a wavelength of the light beam to be measured on the basis of the selected wavelength component.

2. A light wavelength measuring instrument according to claim 1, further comprising:
a filter member for cutting off such wavelength components unnecessary for measuring the wavelength of the light beam to be measured, from the reference light beam emitted from said reference light source.

3. A light wavelength measuring instrument according to claim 1, wherein said first spectrometer spectrum-separates only the reference light beam emitted from said reference light source, and said light wavelength measuring instrument further comprises:
a second detector for detecting the reference light beam spectrum-separated by said first spectrometer;
first control means for calibrating said first spectrometer in such a manner that the reference light beam spectrum-separated by said first spectrometer is detected by said second detector; and
second control means for calibrating said second spectrometer in such a manner that the light beam to be measured spectrum-separated by said second spectrometer is detected by said detector.

4. A light wavelength measuring instrument according to claim 1, wherein said first spectrometer spectrum-separates both the reference light beam emitted from said reference light source and the light beam to be measured emitted from said light source, and said light wavelength measuring instrument further comprises:
control means for calibrating both said first spectrometer and said second spectrometer in such a manner that the light beams to be measured spectrum-separated by both said first and second spectrometers are detected by said detector.

5. A light wavelength measuring instrument according to claim 1, wherein said first spectrometer includes a plurality of spectrum elements for resolving incident light into wavelength components.

6. A light wavelength measuring instrument according to claim 1, wherein said light source is a laser oscillator for emitting a narrow-band laser beam.

7. A light wavelength measuring method comprising:
a first step of spectrum-separating at least a reference light beam from among a light beam to be measured emitted from a light source and the reference light beam emitted from a reference light source by using a first spectrometer;
a second step of spectrum-separating the reference light beam emitted from said first spectrometer and the light beam to be measured emitted from either one of said light source and said first spectrometer by using a second spectrometer having higher resolving power than that of said first spectrometer;
a third step of detecting the light beam to be measured and the reference light beam emitted from said second spectrometer by using a detector; and
a fourth step of selecting a wavelength component approximated to a wavelength of the light beam to be measured detected by said detector from wavelength components of the reference light beam detected by said detector, and measuring a wavelength of the light beam to be measured on the basis of the selected wavelength component.

8. A light wavelength measuring method according to claim 7, further comprising:
a step of cutting off such wavelength components unnecessary for measuring the wavelength of the light beam to be measured, from the reference light beam emitted from said reference light source by using a filter member.

9. A light wavelength measuring method according to claim 7, wherein said first step includes spectrum-separating only the reference light beam emitted from said reference light source by using said first spectrometer, and said light wavelength measuring method further comprises:
a step of detecting the reference light beam spectrum-separated by said first spectrometer by using a second detector;
a step of calibrating said first spectrometer in such a manner that the reference light beam spectrum-separated by said first spectrometer is detected by said second detector; and
a step of calibrating said second spectrometer in such a manner that the light beam to be measured spectrum-separated by said second spectrometer is detected by said detector.

10. A light wavelength measuring method according to claim 7, wherein said first step includes spectrum-separating both the reference light beam emitted from said reference light source and the light beam to be measured emitted from said light source by using said first spectrometer, and said light wavelength measuring method further comprises:
a step of calibrating both said first spectrometer and said second spectrometer in such a manner that the light beams to be measured spectrum-separated by both said first and second spectrometers are detected by said detector.

11. A light wavelength measuring method according to claim 7, wherein said first spectrometer includes a plurality of spectrum elements for resolving incident light into wavelength components.

12. A light wavelength measuring method according to claim 7, wherein said light source is a laser oscillator for emitting a narrow-band laser beam.

13. A laser apparatus comprising:
a laser oscillator for emitting a laser beam;
a reference light source for emitting a reference light beam having a known spectrum distribution;
a first spectrometer for spectrum-separating at least the reference light beam from among the laser beam emitted from said laser oscillator and the reference light beam emitted from said reference light source;
a second spectrometer, having higher resolving power than that of said first spectrometer, for spectrum-separating the reference light beam emitted from said first spectrometer and the laser beam emitted from either one of the laser oscillator and said first spectrometer; and
a detector for detecting the laser beam and the reference light beam emitted from said second spectrometer.

14. A laser apparatus according to claim 13, further comprising:
a filter member for cutting off such wavelength components unnecessary for measuring the wavelength of the light beam to be measured, from the reference light beam emitted from said reference light source.

15. A laser apparatus according to claim 13, further comprising:
light amount adjusting means for adjusting a light amount of a laser beam which reaches said detector.

16. A laser apparatus according to claim 13, further comprising:
a first shutter capable of opening and shutting, for blocking out the laser beam emitted from said laser oscillator; and
a second shutter capable of opening and shutting, for blocking out the reference light beam emitted from said reference light source.

17. A laser apparatus according to claim 13, wherein said first spectrometer spectrum-separates only the reference light beam emitted from said reference light source, and said laser apparatus further comprises:
a second detector for detecting the reference light beam spectrum-separated by said first spectrometer;
first control means for calibrating said first spectrometer in such a manner that the reference light beam spectrum-separated by said first spectrometer is detected by said second detector; and
second control means for calibrating said second spectrometer in such a manner that the light beam to be measured spectrum-separated by said second spectrometer is detected by said detector in order to select a wavelength component approximated to a wavelength of the laser beam detected by said detector from wavelength components of the reference light beam detected by said detector, and also to measure a wavelength of the laser beam on the basis of the selected wavelength component.

18. A laser apparatus according to claim 13, wherein said first spectrometer spectrum-separates both the reference light beam emitted from said reference light source and the light beam to be measured emitted from said light source, and said laser apparatus further comprises:
control means for calibrating both said first spectrometer and said second spectrometer in such a manner that the light beams to be measured spectrum-separated by both said first and second spectrometers are detected by said detector in order to select a wavelength component approximated to a wavelength of the laser beam detected by said detector from wavelength components of the reference light beam detected by said detector, and also to measure a wavelength of the laser beam on the basis of the selected wavelength component.

19. A laser apparatus according to claim 13, wherein said laser oscillator includes:
a laser chamber, when a laser medium is supplied, for generating a laser beam from said laser medium;
a front mirror, arranged on one side of said laser chamber, for reflecting such a laser beam having intensity lower than predetermined intensity, and also transmitting therethrough such a laser beam having intensity higher than the predetermined intensity; and
a narrow-band module, arranged on the other side of said laser chamber, for forming with said front mirror a resonant system to resonate the laser beam so as to amplify the resonated laser beam, and narrowing a bandwidth of the laser beam under amplification.

20. A laser apparatus according to claim 13, wherein said first spectrometer includes a plurality of spectrum elements for resolving incident light into wavelength components.
